(19) United States
(12) Patent Application Publication
(10) Pub. No.: US 2005/0080880 A1
(43) Pub. Date: Apr. 14, 2005

(54) Presenting remote and local information in a web browser

(76) Inventors: Jon Stephenson von Tetzchner, Oslo (NO); Geir Ivarsoy, Oslo (NO)

Correspondence Address: CHRISTIAN D. ABEL, ONSAGERS AS, POSTBOKS 6963 ST. OLAVS PLASS, NORWAY, N-0130, NO

(21) Appl. No.: 10/942,856

(22) Filed: Sep. 17, 2004

Related U.S. Application Data
(60) Provisional application No. 60/507,497, filed on Oct. 2, 2003.

(30) Foreign Application Priority Data
Sep. 26, 2003 (NO) 20034331

(51) Int. Cl. G06F 15/16

(52) U.S. Cl. 709/219; 709/228

(57) ABSTRACT

The invention relates to a method and system for presenting remote and local information in the same user interface by means of a web browser. This is obtained by letting a web browser engine 250 communicate with an additional ECMAScript module 280 that has been designed for the browser, allowing JavaScript environment to be extended with new classes and methods implemented in native code. The module 280 can be conditionally compiled into a build of a web browser on potentially any software platform. Once a build of a web browser has been created with the JavaScript extension functionality enabled, then the JavaScript environment can be extended by placing a specially written library 270 in a certain directory on the electronic device along with a permissions initiation file 260, specifying which Web pages will have access to the extensions.

This application claims the benefit of U.S. Provisional Patent application 60/507,497, filed 2 Oct. 2003.

### FIELD OF THE INVENTION

The present invention relates in general to the technical field of data processing for displaying information on electronic communication terminals. More specifically, the invention relates to presenting remote and local services and information in the same user interface by means of a web browser.

### BACKGROUND OF THE INVENTION—PRIOR ART

A Web browser is a computer program executed at a client computer typically connected to a network such as the Internet, for enabling the client to access content on servers connected to the network. A Web browser includes a user interface, including a computer program portion for addressing a particular server and a particular document on the network. Also, a Web browser includes a computer program portion for displaying the content of an markup language document, in particular a (X)HTML document received from a Web server via the network using the HTTP protocol, on a display connected to the client computer.

In the present disclosure “a markup language document” should be understood as a structured document which in addition to text also includes particular tags that defines a format change or a hypertext link. Applicable examples of markup language documents are HTML or XHTML documents, or alternatively XML documents.

Portable electronic devices incorporating the ability to browse web pages have become wide spread. These devices are typically advanced mobile phones, PDAs connected to a network via e.g. WLAN or Bluetooth etc.

A user of these types of devices has access to both remote and local information. Remote information can be accessed through a web browser, e.g. today's weather forecast presented by a news source. Local information is accessed directly from the applications installed on the electronic device, e.g. a mail can be read by starting a mail program.

In order to view both remote and local information, a user has to switch between different applications. If for example a user is reading a news article from the Internet, she must switch to a calendar program to view the status of upcoming appointments.

U.S. Pat. No. 6,470,381 describes a wireless communications device with a markup language based man-machine interface providing a user interface for telecommunications functionality, including dialling telephone numbers, answering telephone calls, creating messages, sending messages, receiving messages, establishing configuration settings defined in markup language such as HTML, and accessed through a browser program executed by the wireless communication device. This feature enables direct access to Internet and World Wide Web content, such as Web pages, to be integrated with telecommunication functions of the device, and allows Web content to be seamlessly integrated with other data types, since all data presented to the user via the user interface is presented via markup language-based pages. The browser processes an extended form of HTML that provides new tags and attributes that enhance the navigational, logical, and display capabilities of conventional HTML, and particularly adapt HTML to be displayed and used on wireless communication devices with small screen displays.

Although U.S. Pat. No. 6,470,381 describes how to access both remote and local data and present it together via the same user interface, it is limited to accessing features specific for applications on an electronic device by presenting links, on a HTML page, i.e. by pulling the information from the applications, and convert it to HTML code. The main focus is on expanding the HTML language with new tags and properties to enable it to access the local data to be presented as HTML code interpretable by a dedicated browser program. The method and system described is therefore not flexible, and limited to one way interaction between the device native environment and the browser.

The object of the present invention is to dynamically display both remote and local services and information at the same time, and in the same user interface by means of a method and a web browser adapted for this purpose. The meaning of the word “dynamically” is that local applications can push information to the web browser for presentation in the same interface as web specific content. An application can typically do this when an event occurs, e.g. a new mail arrives. It also means that a user can pull information from local applications by selecting an application specific object, linked to an application, from the web browser user interface. It further means that remote services and information can be automatically updated. A user can therefore cover all requirements through the use of just one “HomeScreen” user interface.

### OBJECTS AND SUMMARY OF THE INVENTION

There is a need for a flexible system where it is possible to view both remote and local information at the same time, and in the same interface of the electronic device. A flexible system should be able to update information displayed in the user interface, once a status change of local data, such as incoming call or mail occurs.

The object of the present invention is to provide a method for creating and presenting an interactive “HomeScreen” webpage for the user on her connected device (e.g. a mobile phone connected to the Web). The webpage is intended to be shown when the device is in idle mode and can contain interactive elements that present the user with both remote and local services and information. Remote services mean services available over the telephone network, WLAN or Bluetooth, and local services mean services available from the native device environment (e.g. calendar or messaging information).

Through the use of JavaScript extensions, integration with the native device environment can be achieved allowing the possibility to create any type of services accessible through the HomeScreen webpage. These services can be created in native code on the device.

The objects stated above are achieved by means of a method, a client terminal and a computer program as set forth in the appended set of claims.

### BRIEF LIST OF DRAWINGS

The invention will be described in further detail by reference to the figures, wherein:

FIG. 1 shows an example of a HomeScreen with different information displayed,

FIG. 2 is a block diagram of the components included in the present invention,

FIG. 3 is a flowchart showing the registering of a plug-in according to the invention,

FIG. 4 is a flowchart showing identification and activation of ECMAScript callback,

FIG. 5 is a flowchart showing change of object value by using active call backs,

FIG. 6 is a block diagram of a system for presenting remote and local information.

### DETAILED DESCRIPTION OF THE INVENTION

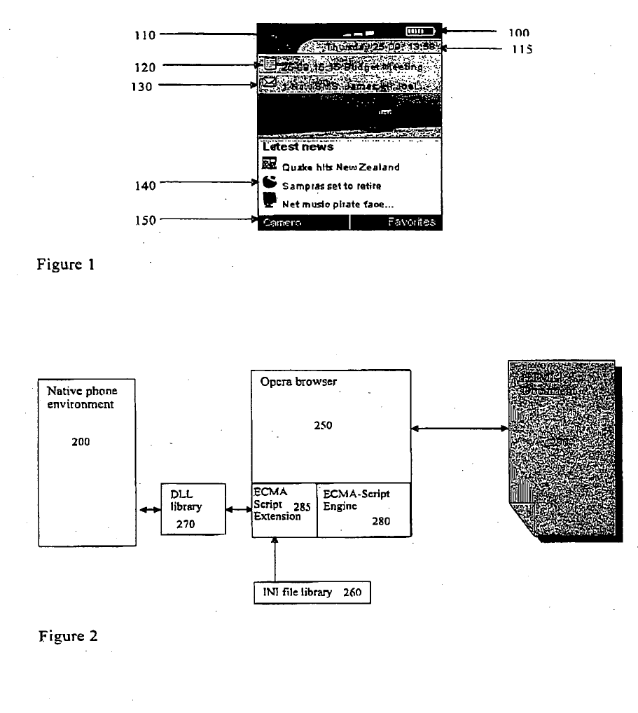

FIG. 1 shows an example of a Web browser according to the present invention, displaying different types of information to a user. In this example, the following functionality is included in the Web browser: displaying of battery status 100 and network connection indicator 110 on the browsing device (local information), updated time and date 115 (local or remote information), updated display of next appointment 120 in calendar (local information), number of new (unread) SMS messages 130 and name of sender of most recently received SMS message (local information) and links to news articles 140 pulled from the Internet (remote information). A soft key indicator 150 is also displayed.

The displayed local information is interactive, i.e. if the links to appointments and messages are pressed; the native calendar and messages applications are launched.

The inventive and flexible browser is achieved by integration of the environment in the native device.

FIG. 2 is a block diagram of the components included in the present invention. The web browser 250 contains an ECMAScript engine 280. This engine is extended by an ECMAScript extension module 285 (the standardized version of the core JavaScript language) that is communicating with the device native environment 200 through a ECMAScript extension library 270. This allows the JavaScript environment to be extended with new classes and methods implemented in native code (rather like Java Native Interface, JNI in Java). The ECMAScript engine 280 and ECMAScript extension module 285 can be conditionally compiled into a build of a web browser on potentially any software platform.

Once a build of a web browser has been created with the JavaScript extension functionality enabled, then the JavaScript environment can be extended by placing a specially written ECMAScript extension library 270 in a certain directory on the electronic device along with a permissions IN-file 260, which specifies which Web pages will have access to the extensions. The INI-file 260 is also important for security reasons.

On browser startup the ECMAScript extension library 270 is loaded to the memory of the electronic device, and the extensions will be available in JavaScript on a HTML document 290 downloaded from a certain domain. The INI-file 260 defines which Web pages that have access to the native phone environment 200 through the ECMAScript extension library 270. It also defines a certain protocol to be used, and port number. The domain can be restricted to local host if desired to allow only HTML document 290 stored locally on the device to have access to the extensions.

The possible functionality of the ECMAScript extension is only limited by the API for the device platform itself. It is also possible for the native code in the ECMAScript extension library 270 to call back to the JavaScript environment (i.e. run. JavaScript code in the JavaScript environment for the current webpage). Using this ability and a browser with support for DOM (Document Object Model), the webpage can be automatically updated when certain events occur (e.g. when a new SMS message is received). The next section explains in more detail how dynamic webpage update works, by use of DOM.

DOM is a standard defined by the W3C (World Wider Web Consortium). This standard is supported by the Opera 7 browser. The DOM functionality present in this browser allows a displayed webpage to be dynamically updated from the JavaScript on the page. This means that a webpage can change its own appearance on user interaction or other event, while only updating the JavaScript that are affected by the event.

This functionality is used in the HomeScreen to dynamically update the HomeScreen webpage on certain events, such as a new SMS message being received. The process that occurs in this particular case is as follows:
1. Native code in the JavaScript extension plug-in requests notification of new incoming SMS messages from the native platform.
2. When a new SMS message is received, the native code in the JavaScript extension is notified.
3. The native code in the JavaScript extension calls back to a certain, predefined method in the JavaScript for the HomeScreen webpage.
4. The JavaScript method uses the DOM API to update the displayed webpage to show that a new SMS message has been received; this update could be very simple (such as just changing some text) or more complex (such as showing a picture or message box).

The following JavaScript method is used to update the HomeScreen webpage on certain events:

function changeElement( tagName, id, newValue ) {

var 1 = document.getElementsByTagName( tagName );
for (var i=0; i<l.length; i++) {

var node = l.item( i );
if (node.id==id) {

node.firstChild.nodeValue = newValue;
break;

}

}

}

This is called for example when a new SMS message is received with new messaging information text to be displayed:
changeElement (“span”, “msgInfo”, msgInfo);

The call causes the following HTML element to be updated with the new messaging information text contained in the msgInfo variable:
<span id=“msgInfo”>(no new)</span>

The use of the DOM API in the HomeScreen is very simple. Far more complex things can be done to the displayed webpage using the DOM functionality. This could even be to the point of changing the displayed webpage completely.

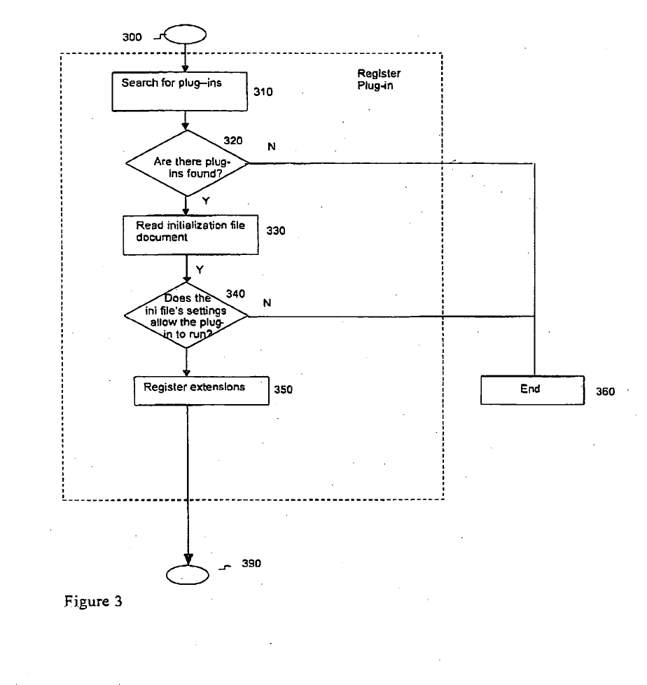

FIG. 3 is a flowchart showing registering of a plug-in according to the invention. The ECMAScript extension library 270 plug-in will enable active call back which is the ability of a device specific application to send a request to the web browser when a specific event occurs, i.e. a new mail arrives. When booting the electronic device, the Web browser will search for plug-ins in step 310. If the plug-in is found an initiation file 260 is read in step 330. If the plug-in is not found, a browser displays the page document without providing active call-backs, step 360. After reading the initiation file 260 in step 330, it is checked whether the initiation file 260 allows the plug-in to run in step 340. If it does, the plug-in is registered in step 350. If not, the plug-in is not registered, and the page is displayed without active call-backs, step 360. When the extensions are registered, the call back functionality is up and running in step 390.

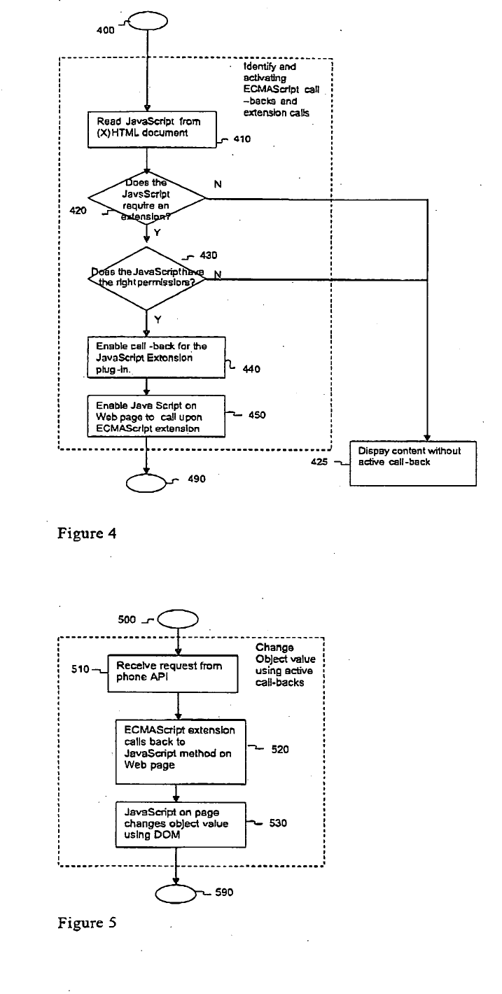

FIG. 4 is a flowchart showing identification and activation of ECMAScript callback and extension calls of JavaScript on the web page. Prior to activating the callback functionality, the browser starts by receiving a (X)HTML document in step 400 and reading the relevant JavaScript from the document in step 410. This is followed by step 420, checking if the JavaScript in the (X)HTML document require an extension. If this is the case, it is in step 430 checked whether the specific JavaScript have the right permission to access local data from the electronic device. If it does not have the right permissions, the content in the (X)HTML document will be displayed without active call-back, step 425. This is also the case for the checking step 420, if the JavaScript does not require an extension.

If the specific JavaScript has the right permission, call-back between an occurrence in the ECMAScript engine and the library plug-in 270 is enabled for the JavaScript Extension in step 440. This will in step 450 result in enabling of JavaScript on the web page to call upon the ECMAScript extensions for displaying of the content with active call-back, step 490.

FIG. 5 is a flowchart showing changing of object value by using active call-backs, described above with reference to FIG. 4. This process starts in step 500 by receiving a request 510 from the Application Interface (API) of the electronic device. In step 520, the ECMAScript extension 285 calls back to JavaScript method on the web page. This is in turn, in step 530, followed by letting the JavaScript on the page change object value using the DOM support in the browser. The displayed content is then updated with the active call-back in step 590.

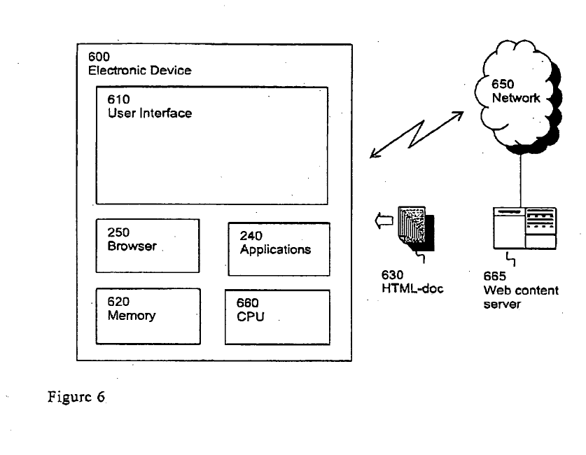

FIG. 6 is a block diagram of a system for presenting remote and local information according to the invention. The system comprises an electronic device 600 with a user interface 610, a web browser 250, device specific applications 240, memory 620, CPU 660 and other components making these devices and applications interact. The remote information is obtained by means of a HTML document 630 received from a network 650 connected to a web content server 665. This HTML document 630 is further processed according to the present invention.

The capability of a web browser, to extend JavaScript with a plug-in library combined with its support for the DOM standard, is a powerful combination. Through JavaScript extensions the JavaScript on certain web pages can be given access to any functionality which is available on a specific platform or device. DOM support allows JavaScript to dynamically change a page in any possible way —anything that can be displayed on a webpage can be created by JavaScript using the DOM API. When these two capabilities are combined the possibilities for creating dynamic, interactive WebPages that can present both local and remote services are endless.

One application example is on a set-up box for watching Web content together with TV-programs and other TV-specific information, which in this case is regarded as local information.

The HomeScreen example presented in FIG. 1 is a simple one page proof of concept. There is no reason however why this idea could not be greatly extended in the future. One possibility would be to create a customizable alternative user interface for the device. Another could be to act as the front end to advanced remote services with minimum bandwidth requirements. Using GSM cell information the HomeScreen could even present location based services to the user. Anything the device can do, can be presented to the user via the familiar and well understood HTML page together with remote information.

1. Method for combining remote and local services and information in the same user interface (610) on an electronic device (600) by means of a web browser (250) loaded in the memory (620) of the electronic device (600), comprising the step of:
loading a library (270) to the memory (620) of the device (600),
loading specific information regarding the electronic device (600) to the memory (620) of the electronic device (600) by means of the library (270),
loading and reading an initiation file (260) defining what remote and local information that is to be loaded to the memory (620),
loading and merging remote and local services and information defined by the initiation file (260),
displaying on the user interface (610) of the electronic device (600), remote and local services and information.

2. Method according to claim 1, where the library (270) is a JavaScript extension library.

3. Method according to claim 1, where the library (270) comprises instructions to receive and pass on, to the web browser (250), data that are specific for the electronic device (600).

4. Method according to claim 3, where the data that are specific for the electronic device (600) are generated by an application (640) embodied on the electronic device (600).

5. Method according to claim 1, where the library (270) comprises instructions to receive and pass on commands from the web browser (250) to the electronic device (600).

6. Method according to claim 5, where the commands control applications (640) embodied on the electronic device (600).

7. Method according to claim 1, where the initiation file (260) comprises definitions of web pages (630) having access to the local services and information on the electronic device (600).

8. Method according to claim 1, where the initiation file (260) comprises protocol and port information.

9. Method according to claim. 1, where the initiation file (260) can be changed locally on the electronic device (600).

10. Method according to claim 1, where the initiation file (260) can be changed by downloading new definitions from the web (665).

11. Method according to claim 1, where the loading and merging of the remote and local information is performed by a CPU (660) embodied on the electronic device (600).

12. Electronic device unit (600) for presenting a web page (630) with remote and local services and information in the same user interface (610) by means of a web browser (250) loaded in the memory of the electronic device (600), comprising:
a processing unit (660),
a memory (620),
a display unit (610),
wherein said processing unit (660) is arranged for performing the following steps:
loading a library (270) to the memory (620) of the electronic device (600),
loading specific information regarding the electronic device (600) to the memory (620) of the electronic device (600) by means of the library (270),
loading and reading an initiation file (260) defining remote and local information that is to be loaded to the memory (620),
loading and merging remote and local services and information defined by the initiation file (260),
displaying on the user interface (610), a web document (630) comprising remote and local services and information.

13. A web browser (250) adapted for combining remote and local services and information in the same user interface (610) on an electronic device (600), comprising:
a JavaScript module (285) adapted to read and send device specific information through a library (270).
